(19) United States
(12) Patent Application Publication
(10) Pub. No.: US 2010/0137118 A1
(43) Pub. Date: Jun. 3, 2010

(54) Vesicant cup

(76) Inventor: Hsi-Ching Chang, Taichung (TW)

Correspondence Address: Hsi-Ching Chang, P.O. Box 215, Taichung, 40099, TW

(21) Appl. No.: 12/320,302

(22) Filed: Jan. 23, 2009

(30) Foreign Application Priority Data
Dec. 1, 2008 (TW) 097146682

(51) Int. Cl. B31D 5/02

(52) U.S. Cl. 493/114; 493/133; 493/162

(57) ABSTRACT

A method for manufacturing a vesicant cup includes a cut fan-shape vesicant plate having thinner upper and lower arcs formed as upper and lower edges. The vesicant plate is rolled and pressed on two stacking joints formed on left and right edges of the vesicant plate respectively. The pressed joints are thinner than other portions of the cup body not being pressed. A lip is formed by rolling up the upper edge outward, and a bottom join is formed by folding up the lower edge inwards. An edge of a vesicant cup bottom is bent downwards as a round joint for connecting and sealing the bottom joint of the vesicant cup body. A thickness of the round joint, bottom joint and the vesicant cup body corresponding to the round joint is thinner than other portions of the vesicant cup body not being pressed.

### FIELD OF THE PRESENT INVENTION

The present invention relates to vesicant cup, and particular to a method for manufacturing a polypropylene (PP) vesicant cup body by conventional paper cup forming equipment.

### DESCRIPTION OF THE PRIOR ART

Accordingly, prior vesicant cup is made by vesicant forming process with single vesicant material such as Taiwan Patents of the no. M330272 (microwave-proof vesicant container) and the no. M302322 (cup for drinks). The process is also the only way being applied until now. The correlative production equipment can only product vesicant containers.

To differ from the prior forming process of the vesicant cup, a method of forming a cup body and bottom in advance and then combining both of them is provided such as a Taiwan patent no. M286203 (Container). The invention claims a container including a hollow body having an opening rolled up an upper flange thereof and a first joint folded up a bottom thereof. A bottom base has a sealing portion to seal the hollow body and a second joint bent downwards an edge thereof to connect the first joint. The invention subsidiary claims that the container is made of low density polymeric resin chosen by one of foamed polystyrene or material composed by polypropylene resin.

In order to have a complete sealed effect, the round first joint and the second joint mentioned above will need a hot rolling pressing process. As mentioned in the description of the prior art of the above patent, a prior container made by paper needs gluing and pressing processes. Also referring to Figs. according to the invention, the cup body is seamless so that the gluing and pressing processes are for connection of the cup body and the bottom base. Thus, the hollow body of the above patent is made by forming process with foamed polypropylene. The production of the container will need a whole set of forming equipment and also need hot pressing equipment for prior paper cup, the cost of the equipments is thus raised with the production material restrained.

Moreover, because of bad ductility of paper, the prior paper containers have defect in the glued and pressed process. Thicknesses of the stacking portions are not changed by the processes, thicker stacking portions is an unsolved problem.

To achieve above object, the present invention provides a A method for manufacturing a vesicant cup comprising: a vesicant cup body made by a cut fan-shape vesicant plate with joints formed on left and right edges of the vesicant plate respectively; the vesicant plate is rolled and pressed on two stacking joints as a hollow cylinder, and a bottom joint formed by folding up the lower edge of the cup body inwards; a vesicant cup bottom being a cut round plate of a vesicant plate; an edge of the vesicant cup bottom being bent downwards as a round joint; wherein the bottom joint of the vesicant cup body and the round joint of the vesicant cup bottom are pressed as one.

The vesicant cup body and the vesicant cup bottom are made of polypropylene (PP), poly styrene (PS) or cross-linked polyethylene (IXPE).

The joints of the vesicant cup body, the bottom joint and the round joint are combined by a process of ultrasonic hot pressing, electrical hot pressing, hot wing pressing, and high frequency pressing. A thickness of the joint of the vesicant cup body is thinner than other portion of the vesicant cup body not being pressed. The bottom joint of the vesicant cup body and the round joint of the vesicant cup bottom are pressed as one so that a thickness of the bottom joint, round joint and the vesicant cup body corresponding to the round joint is thinner than other portion of the vesicant cup body not being pressed.

Furthermore, the present invention provides a The method for manufacturing a vesicant cup further comprising the steps of: a vesicant cup body made by a cut fan-shape vesicant plate having thinner upper and lower arcs formed as upper and lower edges, also having joints formed on left and right edges of the vesicant plate respectively; the vesicant plate is rolled and pressed on two stacking joints as a hollow cylinder, and a bottom joint formed by folding up the lower edge of the cup body inwards; and a vesicant cup bottom being a cut round plate of a vesicant plate; an edge of the vesicant cup bottom being bent downwards as a round joint; wherein the bottom joint of the vesicant cup body and the round joint of the vesicant cup bottom are pressed as one.

The vesicant cup body and the vesicant cup bottom are made of one of polypropylene (PP), poly styrene (PS), cross-linked polyethylene (IXPE). A lip is formed by rolling up the upper edge of the vesicant cup body outwards.

Therefore, aiming at the only forming process of the vesicant material, the inventor successfully provides the present invention in accordance with experiences of producing paper container and production equipments on hand and under adequate considerations and times of trail and experiment.

### SUMMARY OF THE PRESENT INVENTION

The primary object of the present invention is to provide a manufacturing process to produce vesicant cups with the same structure of paper cups and by the same production equipment of paper cup so that two different types of cup can be produced by the same production equipment. The cost of production equipment is lowered by the entirely different manufacturing method from a prior one.

### BRIEF DESCRIPTION OF THE DRAWINGS

FIG. 1A is a schematic view showing a process flow of a preferable embodiment of the present invention.

FIG. 1B is a schematic view showing another process flow of a preferable embodiment of the present invention.

FIG. 1C is a schematic view showing a further process flow of a preferable embodiment of the present invention.

FIG. 2A is an assembly cross section view showing the preferable embodiment of the present invention.

FIG. 2B is an enlarged view of FIG. 2A.

FIG. 3 is a side view showing a cross section of the preferable embodiment of the present invention.

FIG. 4 is a top view showing a cross section of a cup body of the preferable embodiment of the present invention.

### DETAILED DESCRIPTION OF THE INVENTION

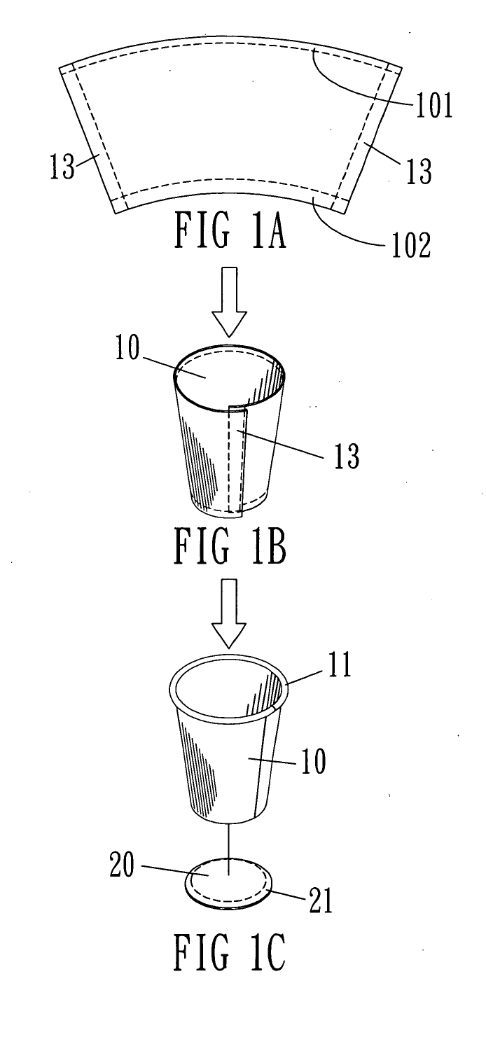

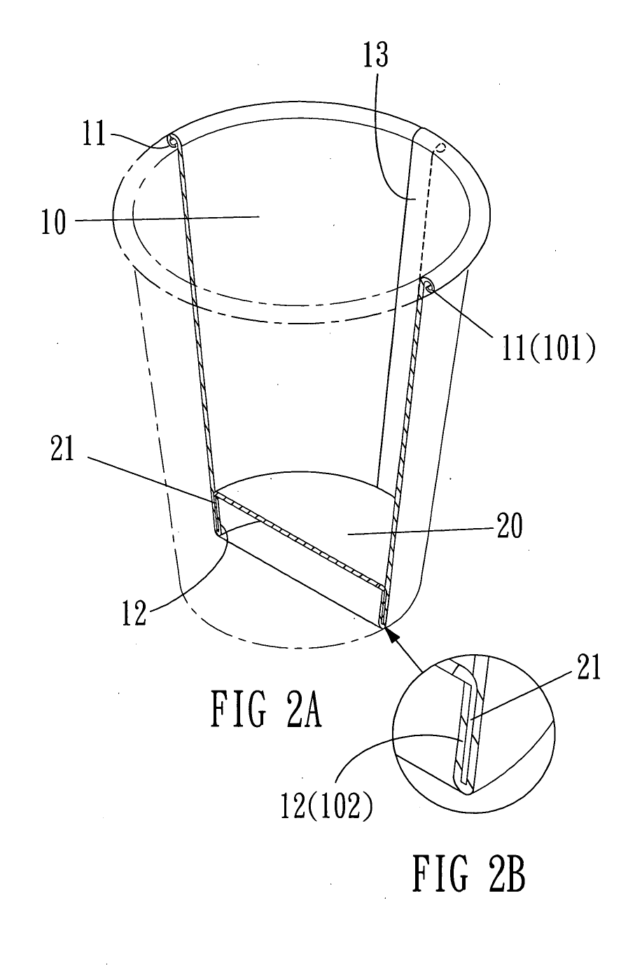

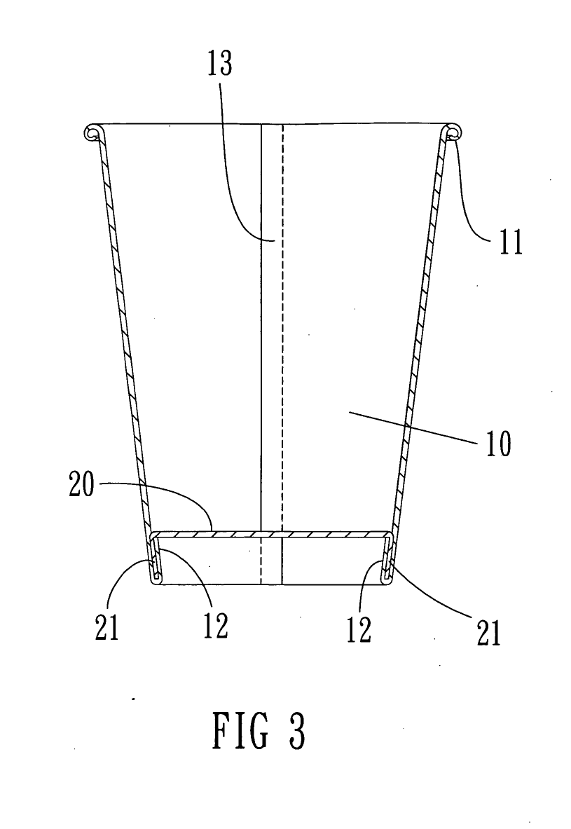

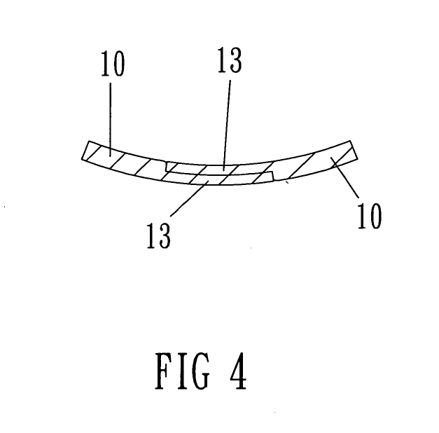

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims. Firstly, referring to FIGS. 1A, 1B, 1C, 2A, 2B, 3 and 4, a method for manufacturing a vesicant cup is shown and described in the following.

A vesicant cup body 10 is made by a cut fan-shape vesicant plate. Upper and lower arcs of the vesicant plate are formed as upper and lower edge 101, 102 with a thinner thickness than that of the vesicant plate. The vesicant plate is rolled and pressed on two stacking joints 13 formed on left and right edges of the vesicant plate respectively so that a cup body without a bottom is formed. A lip 11 is formed by rolling up the upper edge 101 outward, and a bottom join 12 is formed by folding up the lower edge 102 inwards. The pressed joints 13 are thinner than other portions of the cup body 10 not being pressed.

A vesicant cup bottom 20 is a cut round plate of a vesicant plate. An edge of the vesicant cup bottom 20 is bent downwards as a round joint 21. The bottom joint 12 of the vesicant cup body 10 and the round joint 21 of the vesicant cup bottom 20 are pressed as one so that a thickness of the bottom joint 12 and the vesicant cup body 10 corresponding to the round joint 21 is thinner than other portions not being pressed of the vesicant cup body 10. The round joint 21 being pressed and combined to the bottom joint 12 is thinner than other portions of the vesicant cup bottom 20 not being pressed.

Moreover, the vesicant cup body 10 and the vesicant cup bottom 20 are made of same vesicant material such as one of polypropylene (PP), poly styrene (PS), and cross-linked polyethylene (IXPE).

Otherwise, the vesicant material can be chosen by one of Polylactic Acid (PLA), the Polyethylene Terephthalate (Biomax 4024 PET) of the US DuPond, the biodegradable Fepol of the Taiwan Far Eastern Textile, the biodegradable Ecoflex and the Ecovio of the Germany BASF.

The joint 13 of the vesicant cup body 10 and the bottom joint 12 and the round joint 21 are combined by a process of ultrasonic hot pressing, electrical hot pressing, hot wing pressing, high frequency pressing.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for manufacturing a vesicant cup comprising:
a vesicant cup body made by a cut fan-shape vesicant plate with joints formed on left and right edges of the vesicant plate respectively; the
vesicant plate is rolled and pressed on two stacking joints as a hollow cylinder, and a bottom joint formed by folding up the lower edge of the cup body inwards; and
a vesicant cup bottom being a cut round plate of a vesicant plate; an edge of the vesicant cup bottom being bent downwards as a round joint;
wherein the bottom joint of the vesicant cup body and the round joint of the vesicant cup bottom are pressed as one.

2. The method for manufacturing a vesicant cup as claimed in claim 1, wherein the vesicant cup body and the vesicant cup bottom are made of polypropylene (PP).

3. The method for manufacturing a vesicant cup as claimed in claim 1, wherein the vesicant cup body and the vesicant cup bottom are made of poly styrene (PS).

4. The method for manufacturing a vesicant cup as claimed in claim 1, wherein the vesicant cup body and the vesicant cup bottom are made of cross-linked polyethylene (IXPE).

5. The method for manufacturing a vesicant cup as claimed in claim 1, wherein the joints of the vesicant cup body, the bottom joint and the round joint are combined by a process of ultrasonic hot pressing, electrical hot pressing, hot wing pressing, and high frequency pressing.

6. The method for manufacturing a vesicant cup as claimed in claim 1, wherein a thickness of the joint of the vesicant cup body is thinner than other portion of the vesicant cup body not being pressed.

7. The method for manufacturing a vesicant cup as claimed in claim 1, wherein the bottom joint of the vesicant cup body and the round joint of the vesicant cup bottom are pressed as one so that a thickness of the bottom joint, round joint and the vesicant cup body corresponding to the round joint is thinner than other portion of the vesicant cup body not being pressed.

8. The method for manufacturing a vesicant cup further comprising
a vesicant cup body made by a cut fan-shape vesicant plate having thinner upper and lower arcs formed as upper and lower edges, also having joints formed on left and right edges of the vesicant plate respectively; the vesicant plate is rolled and pressed on two stacking joints as a hollow cylinder, and a bottom joint formed by folding up the lower edge of the cup body inwards; and
a vesicant cup bottom being a cut round plate of a vesicant plate; an edge of the vesicant cup bottom being bent downwards as a round joint; and
wherein the bottom joint of the vesicant cup body and the round joint of the vesicant cup bottom are pressed as one.

9. The method for manufacturing a vesicant cup as claimed in claim 8, wherein the vesicant cup body and the vesicant cup bottom are made of one of polypropylene (PP), poly styrene (PS), cross-linked polyethylene (IXPE).

10. The method for manufacturing a vesicant cup as claimed in claim 8, wherein a lip is formed by rolling up the upper edge of the vesicant cup body outwards.
